(19) United States
(12) Patent Application Publication
(10) Pub. No.: US 2002/0083419 A1
(43) Pub. Date: Jun. 27, 2002

(54) Method for using software emulating signal generator

(76) Inventors: Ye Li, Tienchin (CN); Tong S. Chen, Taipei (TW); Kuang Shin Lin, Taipei (TW)

Correspondence Address: BIRCH STEWART KOLASCH & BIRCH, PO BOX 747, FALLS CHURCH, VA, 22040-0747, US

(21) Appl. No.: 09/742,086

(22) Filed: Dec. 22, 2000

(51) Int. Cl. G06F 9/44

(52) U.S. Cl. 717/134

(57) ABSTRACT

A method for using software emulating signal generator, suitable for a Windows operating system of a computer, the computer having a storage device, comprising the steps of: getting a frequency and an amplitude of broadcasting sound data set by a user; transmitting the frequency and the amplitude to an initializing module; initializing the frequency and the amplitude by the initializing module to obtain initializing sound data; and using a broadcast module to broadcast the initializing sound data. A software emulating signal generator, suitable for a Windows operating system of a computer, the computer having a storage device, comprising: an adjusting frequency and amplitude module, for getting a frequency and an amplitude of broadcasting sound data set by a user; an initializing module, for initializing the frequency and the amplitude to obtain initializing sound data; and a broadcast module, for broadcasting the initializing sound data.

### BACKGROUND OF THE INVENTION

1. Field of the Invention

The present invention relates to a signal generator, and more particularly to a method for using software emulating a signal generator.

2. Background

In practice, sound cards need to be tested. Sound files are usually used to test the sound card, besides, a signal generator which can cause varied frequencies is used to input signals into the sound card. The output signals are then retrieved and analyzed for assessing the sound card. There are two solutions for causing varied frequencies to test the sound card in the arts.

The first method is via the frequency modulation sounder to give off signals of varied frequencies. However, this method has the following disadvantages: (1) The method is only suitable for DOS operating systems. In Windows operating systems, the control of registers is more complex, and one has to be familiar with the functions of the hardware and the operations of drivers. (2) When the settings of the hardware have changed, corresponding modifications must be done, thus making complex errors occur easily.

The second method employs connecting an outside signal generator, so no doubt the cost will increase.

### SUMMARY OF THE INVENTION

The object of the present invention is to solve the above-mentioned problems and to provide a method for using software emulating a signal generator.

According to the present invention, a method for using software emulating signal generators, suitable for a Windows operating system of a computer, with the computer having a storage device, comprising the steps of: getting a frequency and an amplitude of broadcasting sound data which is set by a user; transmitting the frequency and the amplitude to an initializing module; initializing the frequency and the amplitude by the initializing module to obtain initializing sound data; and using a broadcast module to broadcast the initializing sound data.

According to the present invention, a software emulating signal generator, suitable for a Windows operating system of a computer, the computer have a storage device, comprises: an adjusting frequency and amplitude module, for getting a frequency and an amplitude of broadcasting sound data set by a user; an initializing module, for initializing the frequency and the amplitude to obtain initializing sound data; and a broadcast module, for broadcasting the initializing sound data.

### BRIEF DESCRIPTION OF THE DRAWINGS

The present invention will be described in detail with reference to the illustrated embodiments and the accompanying drawings, in which:

FIGS. 1A to 1C show the working principle of sampling the sound signal.

FIG. 2 is a flow chart showing the steps for the broadcast module of the software emulating signal generator in this invention.

FIG. 3 is a flow chart showing the steps for the adjusting frequency and amplitude module of the software emulating signal generator in this invention.

### DETAILED DESCRIPTION OF THE INVENTION

The software emulating signal generator includes three modules, an adjusting frequency and amplitude module, an initializing module and a broadcast module. The software emulating signal generator is suitable for a Windows operating system of a computer which has a storage device.

Each module will now be explained:

The initializing module initializes a frequency and an amplitude of broadcasting sound data, set by a user, to obtain initializing sound data. In order to generate a signal, the initializing module first sets a storage space form the storage device. Before emulating a sound signal, the software emulating signal generator assumes that the sound signal exists. The software emulating signal generator then samples the sound signal. The initializing module then according to a fourier formula gives an initial value to the storage space. The fourier formula is

X*(t)=Xa(t)Pδ(t)=ΣXa(nT)δ (t−nT), (∞>n>−∞),

F(t)=A0/2+Σ(An Sin α Cos nωt+An Cos α Sin nωt), (n>=1)

where X is frequency, T is sampling period, T=2π/ω, α is initial phase, ω is angle frequency, A is amplitude and t is sampling time. Presume to set 2 kilobytes space, so n is from 1 to 2000. If sampling period is π, amplitude is 1000, initial phase is 0, sampling frequency is 11025 Hz and sound frequency is 100 Hz. Substitute the above data to the formula, this 2 kilobytes space is F(t)=1000*Sin(n2π*100/11025), 0<n2K.

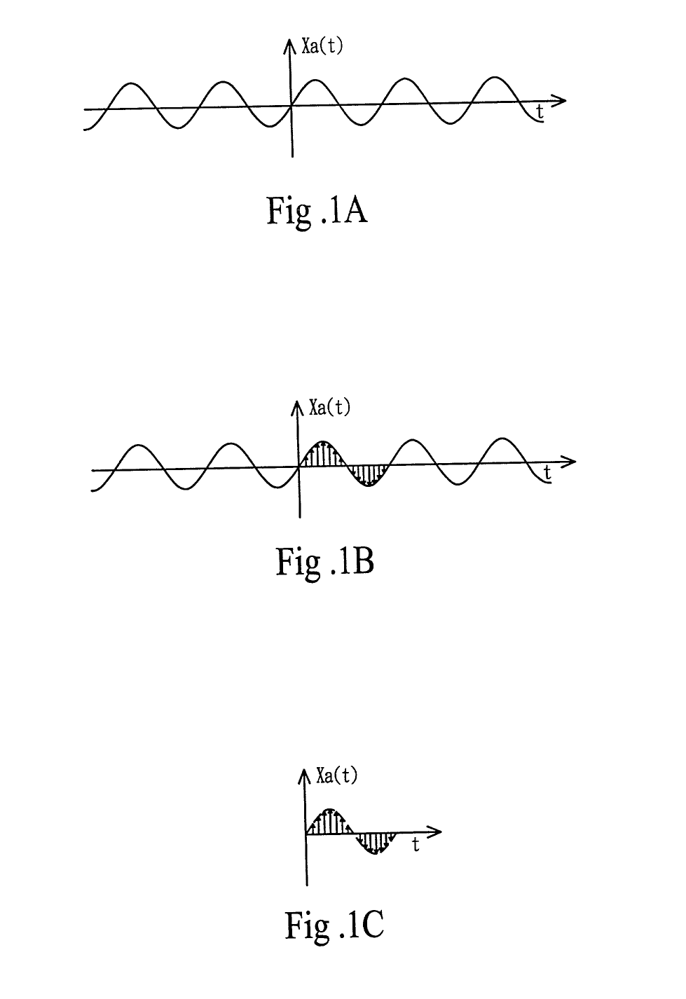

FIGS. 1A to 1C show the working principle of sampling the sound signal. FIG. 1A is a sound signal. FIG. 1B shows sampling the sound signal of FIG. 1A. FIG. 1C shows connecting the sampling points. It can be seen that the waveform of FIG. 1C is similar to that of FIG. 1A.

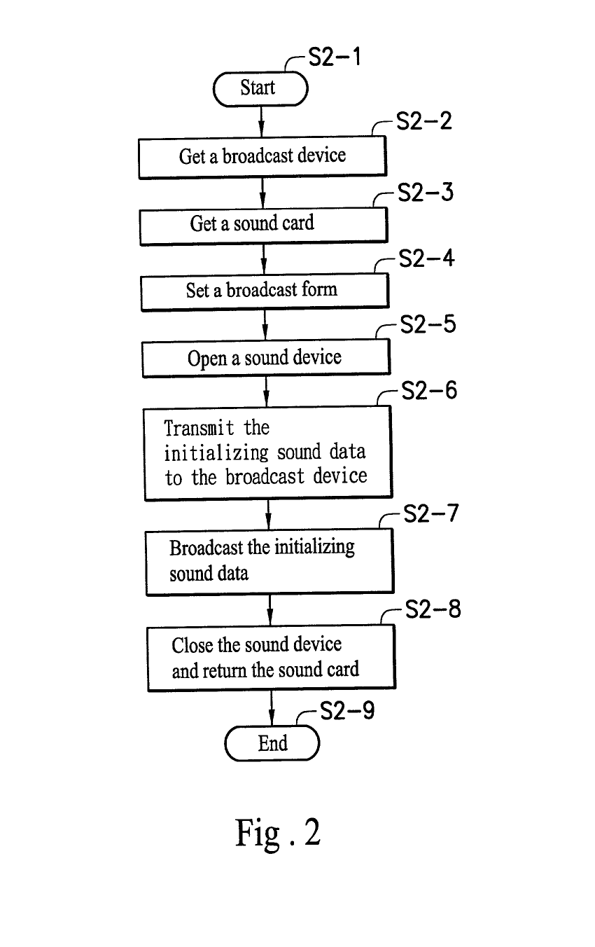

Referring to FIG. 2 a flow chart showing the steps for the broadcast module of the software emulating signal generator in this invention is illustrated. The broadcast module first gets a broadcast device, as shown in step S2-2.

In step S2-3, the broadcast module gets a sound card.

In step S2-4, the broadcast module sets a broadcast form.

In step S2-5, the broadcast module opens a sound device.

In step S2-6, the broadcast module transmits the initializing sound data to the broadcast device.

In step S2-7, the broadcast module broadcasts the initializing sound data.

In step S2-8, the broadcast module closes the sound device and returns the sound card.

In step S2-9, the broadcast module terminates.

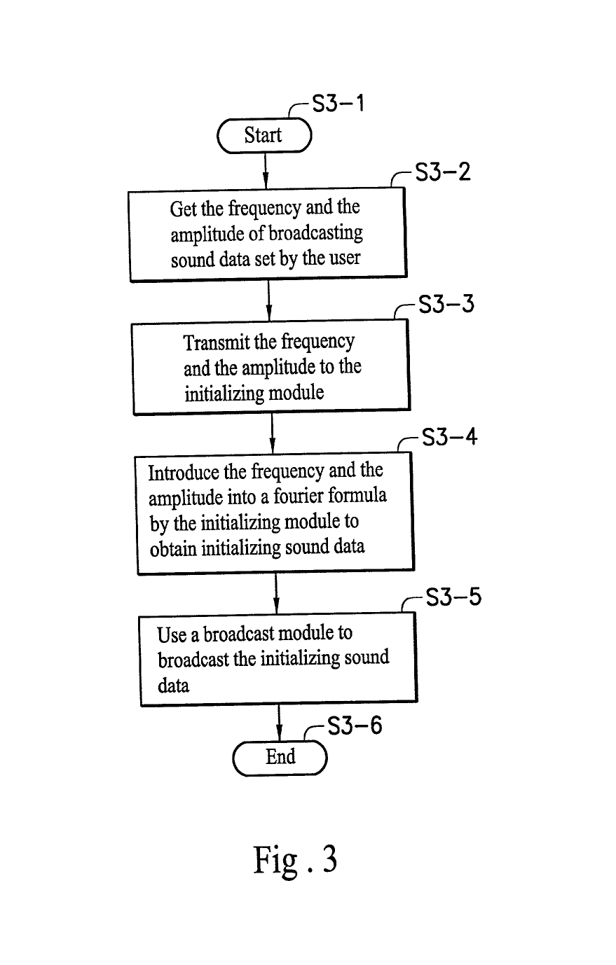

The sound broadcasted by the broadcast module is monotone according to a certain frequency and a certain amplitude. If a frequency is changed, a tone will be changed too. If an amplitude is changed, a volume will be changed too. FIG. 3 illustrates a flow chart showing the steps for the adjusting frequency and amplitude module of the software emulating signal generator in this invention. In step S3-2, the adjusting frequency and amplitude module gets the frequency and the amplitude of broadcasting sound data set by the user.

In step S3-3, the adjusting frequency and amplitude module transmits the frequency and the amplitude to the initializing module.

In step S3-4, the adjusting frequency and amplitude module introduces the frequency and the amplitude into a fourier formula by the initializing module to obtain initializing sound data.

In step S3-5, the adjusting frequency and amplitude module uses a broadcast module to broadcast said initializing sound data.

In step S3-6, the adjusting frequency and amplitude module terminates.

The software emulating signal generator of the invention can simulate signals of varied frequency. The operations, generating signal, transmitting signal, changing frequency, of the software emulating signal generator is only accomplished by the programs, thus is simpler than a physical signal generator.

A method for using software emulating signal generator according to the preferred embodiment of the present invention will now be described.

A method for using software emulating signal generator according to the preferred embodiment comprising the steps of:

(a) getting a frequency and an amplitude of broadcasting sound data set by a user; (b) transmitting the frequency and the amplitude to an initializing module; and (c) using a broadcast module to broadcast the initializing sound data. The step (b) includes performing the initializing module given above. The step (c) includes performing the broadcast module given above.

### EXAMPLE

The noise test of a sound card is an example of the software emulating signal generator of the present invention. The principle of the noise test of a sound card is first to record the sound, which is given off form the sound card, through the sound card. Then, the signal to noise ratio (SNR) is taken to get a db value. Via the examination of the db value can analyze the degree of the noise of the sound card.

The noise test of a sound card is carried out as following. A frequency and an amplitude of a signal is first given to the software emulating signal generator. A recording module is executed to record. A sound is given off by the software emulating signal generator. The software emulating signal generator and the recording module are closed. Finally, the data of the software emulating signal generator is compared with the data of a recorder. From the compared results, we can obtain the difference in the sound of the sound card. The processes will be described in detail as following.

1. Noise data: Two kilobytes data of none sound is recorded. The two kilobytes data is the noise data caused by the hardware of the sound card when working. In order to prevent too much energy from being lost, a wire can be used to correct the input port and the output port.

2. Retrieve data: A recording device is opened and a 2 kilobytes space is prepared for saving the recorded data.

3. Sound data: The volume control needs to be set before broadcasting. The volume is set to a maximum 65535 and the mute of the wave is off. In order to acquire accuracy, 100 Hz, 200 Hz, 400 Hz, 800 Hz and 1600 Hz, five frequencies of the sound are selected to test. The amplitude value is set to 32000. These five sounds are generated according to the sampling formula to sample varied values. These five sounds are each broadcasted by using the software emulating a signal generator.

4. After the broadcasting, each datum is squared, that is the power value of the signal in that point. The disposition of the sound signals is to get the average of the two kilobytes points, due to each signal of the same frequency have been recorded for two kilobytes points. The disposition of the noise signals is the same. The signal to noise ratio (SNR) is taken to get a db value. db=10 Log(Wi/W0), where Wi is the power value of the signal, W0 is the power value of the noise. Five db values are obtained by the SNR of five frequencies of signal and noise. In practice, it has been verified that the noise of the sound card is low and can be ignored if a db value is above 10.

While the invention has been described with reference to various illustrative embodiments, the description is not intended to be construed in a limiting sense. Various modifications of the illustrative embodiments, as well as other embodiments of the invention, will be apparent to those persons skilled in the art upon reference to this description. It is therefore contemplated that the appended claims will cover any such modifications or embodiments as may fall within the scope of the invention defined by the following claims and their equivalents.

What is claimed is:

1. A method for using software emulating a signal generator, suitable for a Windows operating system of a computer, with the computer having a storage device, comprising the steps of:
getting a frequency and an amplitude of broadcasting sound data set by a user;
transmitting the frequency and the amplitude to an initializing module;
initializing the frequency and the amplitude by the initializing module to obtain initializing sound data; and
using a broadcast module to broadcast the initializing sound data.

2. The method as recited in claim 1, wherein the initializing module further comprises the steps of:
setting a storage space from the storage device; and
according to a Fourier formula giving an initial value to the storage space, wherein the Fourier formula is
X*(t)=Xa(t)Pδ(t)=ΣXa(nT)δ (t−nT), (∞>n>−∞),
F(t)=A0/2+Σ(An Sin α Cos nωt+An Cos α Sin nωt), (n>=1)
where X is frequency, T is sampling period, T=2π/ω, α is initial phase, ω is angle frequency and t is sampling time.

3. The system as recited in claim 1, wherein the broadcast module further comprises the steps of:
getting a broadcast device;
getting a sound card;
setting a broadcast form;
opening a sound device;
transmitting the initializing sound data to the broadcast device;
broadcasting the initializing sound data; and
closing the sound device and returning the sound card.

4. A software emulating signal generator, suitable for a Windows operating system of a computer, the computer having a storage device, comprising:
an adjusting frequency and amplitude module, for getting a frequency and an amplitude of broadcasting sound data set by a user;
an initializing module, for initializing the frequency and the amplitude to obtain initializing sound data; and
a broadcast module, for broadcasting the initializing sound data.

5. The software emulating signal generator as recited in claim 4, wherein the adjusting frequency and amplitude module further comprises the steps of:
getting the frequency and the amplitude of broadcasting sound data set by the user;
transmitting the frequency and the amplitude to the initializing module;
introducing the frequency and the amplitude into a Fourier formula by the initializing module to obtain initializing sound data; and
using a broadcast module to broadcast the initializing sound data.

6. The software emulating signal generator as recited in claim 4, wherein said initializing module further comprises the steps of:
setting a storage space form said storage device; and
according to a Fourier formula giving an initial value to said storage space, wherein said Fourier formula is
X*(t)=Xa(t)Pδ (t)=ΣXa(nT)δ (t−nT), (∞>n>−∞),
F(t)=A0/2+Σ(An Sin α Cos nωt+An Cos α Sin nωt), (n>=1)
where X is frequency, T is sampling period, T=2π/ω, α is initial phase, ω is angle frequency and t is sampling time.

7. The software emulating signal generator as recited in claim 4, wherein said broadcast module further comprises the steps of:
getting a broadcast device;
getting a sound card;
setting a broadcast form;
opening a sound device;
transmitting said initializing sound data to said broadcast device;
broadcasting said initializing sound data; and
closing said sound device and returning said sound card.
